(19) United States
(12) Patent Application Publication
(10) Pub. No.: US 2022/0237528 A1
(43) Pub. Date: Jul. 28, 2022

(54) GROUP MEETING GUIDANCE SYSTEM

(71) Applicant: Cameron Marsh, Edwardsville, IL (US)

(72) Inventor: Cameron Marsh, Edwardsville, IL (US)

(21) Appl. No.: 17/569,972

(22) Filed: Jan. 6, 2022

Related U.S. Application Data
(60) Provisional application No. 63/140,456, filed on Jan. 22, 2021.

(51) Int. Cl. G06Q 10/02; G01C 21/00

(52) U.S. Cl. CPC G06Q 10/025; G01C 21/3811

(57) ABSTRACT

The system and method communicate several different locations for an upcoming meeting of a group of users to user devices of the users, and, for each of the different locations, receive a user indication from each of the users of a preference for the upcoming meeting at the location or a disfavor for the upcoming meeting at the location. The system and method also select one of the locations as a selected location for the upcoming meeting based on the user indications, and communicate the selected location to the user devices.

### CROSS-REFERENCE TO RELATED APPLICATIONS

This application claims priority to U.S. Provisional Application No. 63/140,456 (filed 22 Jan. 2021), the entire disclosure of which is incorporated herein by reference.

### BACKGROUND

### Technical Field

The subject matter described herein relates to systems and methods that guide interactions (e.g., meetings) of groups of people.

### Discussion of Art

Many social interactive applications and websites are available today, such as FACEBOOK, TWITTER, TINDER, and the like. Additionally, many applications and websites can provide reviews of different businesses, such as YELP, GOOGLE, TRIPADVISOR, etc. But, these applications and websites do not assist groups of people in deciding where to meet for face-to-face interactions. While the social interactive applications and websites assist people in interacting with each other from afar, these applications and websites may not assist in finding places or businesses for people to meet up in person.

### BRIEF DESCRIPTION

In one embodiment, a method includes communicating several different locations for an upcoming meeting of a group of users to user devices of the users, and, for each of the different locations, receiving a user indication from each of the users of a preference for the upcoming meeting at the location or a disfavor for the upcoming meeting at the location. The method also includes selecting one of the locations as a selected location for the upcoming meeting based on the user indications, and communicating the selected location to the user devices.

In one embodiment, a system includes one or more processors configured to communicate several different locations for an upcoming meeting of a group of users to user devices of the users. The one or more processors are configured to, for each of the different locations, receive a user indication from each of the users of a preference for the upcoming meeting at the location or a disfavor for the upcoming meeting at the location. The one or more processors also are configured to select one of the locations as a selected location for the upcoming meeting based on the user indications and communicate the selected location that is selected to the user devices.

### BRIEF DESCRIPTION OF THE DRAWINGS

The inventive subject matter may be understood from reading the following description of non-limiting embodiments, with reference to the attached drawings, wherein below:

FIG. 1 schematically illustrates one example of a group meeting guidance system; and

FIG. 2 illustrates one example of a flowchart of a method for guiding a group of users to select a location for a meeting.

### DETAILED DESCRIPTION

Embodiments of the subject matter described herein relate to systems and methods that guide social in-person interactions between groups of people, such as by assisting groups in finding restaurants, coffee shops, bars, movies, or the like, that may be desirable and convenient for those in the group. The systems and methods can be used to assist these groups in finding locations to meet for socializing, working, or the like, in a place (e.g., business) that is preferred by the group in a much shorter timeframe and without repeated communications between and among members of the group.

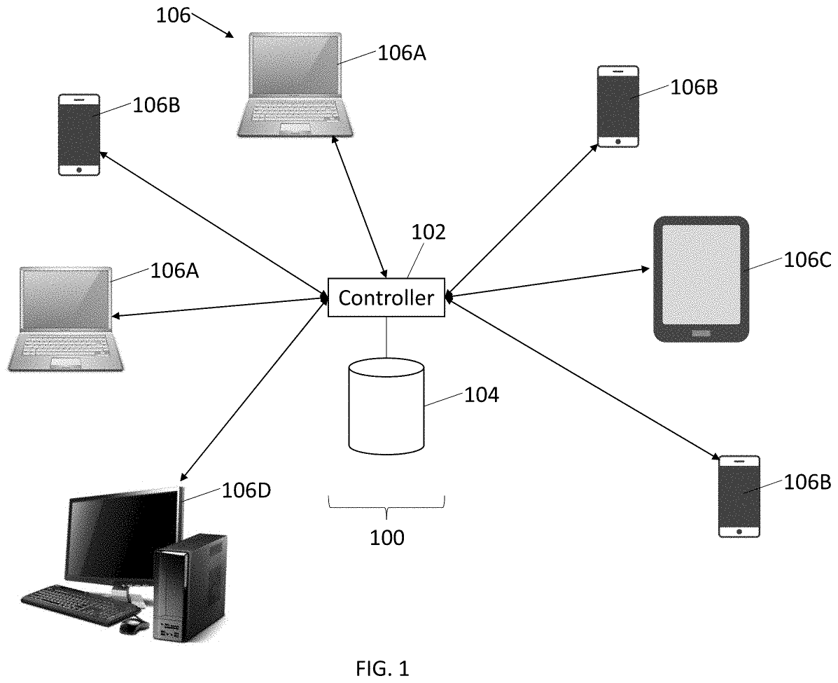

FIG. 1 schematically illustrates one example of a group meeting guidance system 100. The system includes a controller 102 that represents a computing device having one or more processors (e.g., one or more microprocessors, one or more integrated circuits, one or more field programmable gate arrays, etc.) that perform the operations described herein in connection with the controller. The controller can be or include one or more computer servers or other types of computers. The controller includes or is connected with one or more tangible and non-transitory computer readable storage media 104, such as a computer memory (e.g., computer hard drive, removable disc, or the like). The controller can include communicate with plural user devices 106 (e.g., devices 106A-D) via one or more networks, such as the Internet, local area networks, wide area networks, etc. The user devices can represent mobile phones (e.g., devices 106B), tablet computers (e.g., device 106C), desktop computers (e.g., devices 106D), laptop computers (e.g., devices 106A), and the like.

Users of the user devices can provide input to the user devices to cause at least one of the devices to send a request signal to the controller. This request signal can indicate that a group of two or more users would like to meet with each other in a face-to-face setting. The request signal can identify the users that would like to meet. The controller can send invitation signals to the users identified as wanting to meet (or that at least one user selected as being participants at the meeting or get-together) as a meeting invitation.

The controller can recommend one or more places for the meeting to occur. The meeting can be for a dinner among friends, a business dinner, drinks with friends, happy hour, business drinks, a movie, a sporting event, or the like. In one example, the controller can determine locations of the persons in the group. These locations can be reported by the user devices to the controller. The memory can store locations (e.g., addresses) of various potential meeting locations and the controller can compare these locations to the user locations. From this comparison, the controller can determine which potential meeting locations to propose to the users in the group. For example, the controller can direct the user devices to display an image, icon, and/or other information associated with locations (e.g., an image of the front of a restaurant) that are within a threshold distance of the users.

Each of the users can then use his or her device to indicate a preference or dislike of the potential meeting location. As one example, the controller can direct a user device to display an image, name, and/or logo associated with a business at a first location of the potential locations. The user can then provide input to indicate that the user likes or dislikes the business at that location. For example, the user can swipe right on the screen of the user device, can select a “thumbs up” icon displayed on the user device, can type in another input, can speak an input, or the like, to indicate that the user likes the business at that location. Alternatively, the user can swipe left on the screen, select a “thumbs down” icon, can type in another input, can speak an input, or the like, to indicate that the user does not like the business at that location. The user device can send a preference signal to the controller to indicate whether the user indicated that he or she would like for the group to meet at the business at that location or that the user indicated that he or she would not like for the group to meet at the business at that location. The controller can direct the user device to then display one or more other potential meeting locations in a similar way. For example, the controller can direct the user devices to display a sequence of the potential meeting locations, with the user devices receiving the preference feedback from the users (described above) for each potential meeting location. The controller receives the preferences from the preference signals sent by the user devices, and determines which of the potential locations was most preferred by the users. For example, three different restaurants A, B, and C may be presented to five users D, E, F, G, and H. Two users (D and E) may indicate that they like restaurant A, one user (user D) may indicate that he or she likes restaurant B, and four users (users E, F, G, and H) may indicate that they like restaurant C. The controller may select the restaurant C as the group selected location. If the same number of users indicate a preference for two or more of the potential locations, then the controller may randomly select one of these locations or may otherwise select one of the locations. For example, the controller may direct the user devices to list the most-preferred locations on the user devices so the users can again indicate their preferences. Instead of presenting all of the potential meeting locations, however, the user devices may only display those locations that received the most users indicating their preference for those locations. In continuing with the above example, if four users like restaurants B and C but only three like restaurant A, then the controller can direct the display devices to present only restaurants B and C to the users (and not A) to see if more users now prefer one restaurant over the other.

The selected location can then be presented to the users. The controller can send a selection signal to the user devices indicating which location was selected. The user devices can notify the users which location or business was selected for the meeting. Optionally, the controller may also communicate information regarding the business at that location, such as a copy of the menu, a link to make a reservation for the group at the business, a link to purchase tickets or food at the business ahead of time, etc.

The controller optionally may perform the same location-selection process described above for determining a time for the users in the group to meet. For example, the controller can direct the user devices to display different times to meet for lunch, and the users can use the user devices to indicate which times are preferred or not preferred. Based on the user responses, the controller can determine which time is preferred by more people in the group (relative to other times).

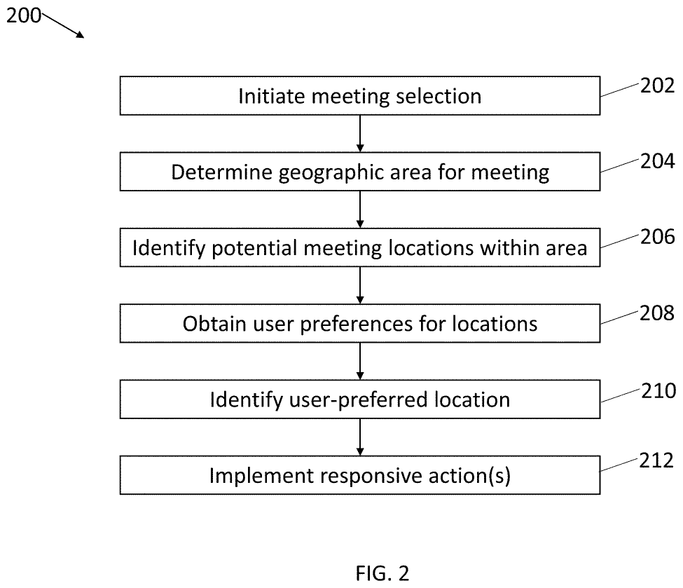

FIG. 2 illustrates one example of a flowchart of a method 200 for guiding a group of users to select a location for a meeting. The method can represent the operations performed by the system described above. At 202, a meeting selection may be initiated. For example, a user may input information into his or her user device indicating a desire to meet a group of other users (e.g., for lunch, dinner, drinks, a movie, a sporting event, etc.). At 204, a geographic area for the meeting is determined. The area can be identified by the controller based on current locations of the users and/or a location identified by the user that initiated the meeting. At 206, a set of potential meeting locations is identified. The controller can refer to a list, table, or other data structure in the memory that stores locations of restaurants, bars, arenas, or the like, within the geographic area. The controller can then communicate these potential locations for the meeting to the user devices.

At 208, the potential locations are presented to the users and user preferences are obtained. As described above, the user devices can display the potential meeting locations to the users, and the users can indicate their like or dislike for each of the potential locations (or at least a designated number of potential locations). These user preferences can then be communicated from the user devices to the controller. At 210, the controller examines the user preferences to determine whether any potential location received more user preferences (e.g., more users indicating their like for the potential location) than other potential locations. If the user preferences indicate a location that is preferred or liked by more users than one or more other (or all other) potential locations, then that location may be selected for the meeting. If the user preferences do not indicate a location that is preferred or liked by more users than one or more other (or all other) potential locations, then the controller may direct the user devices to present a smaller set of the locations to the users again (e.g., those locations receiving more likes or user preferences than others) or may randomly select one of the more preferred or liked locations. At 212, one or more responsive actions may be taken. The controller can direct the user devices to display the selected location to the users in the group. Optionally, the controller can contact the business of the selected location and reserve a table or other space for the group. Optionally, the controller can pre-purchase food, drinks, tickets, or the like, at the selected location.

In one embodiment, a method includes communicating several different locations for an upcoming meeting of a group of users to user devices of the users, and, for each of the different locations, receiving a user indication from each of the users of a preference for the upcoming meeting at the location or a disfavor for the upcoming meeting at the location. The method also includes selecting one of the locations as a selected location for the upcoming meeting based on the user indications, and communicating the selected location to the user devices.

Optionally, the locations are associated with different businesses.

Optionally, the locations are associated with different restaurants.

Optionally, the locations are associated with different bars.

Optionally, the locations are associated with different sporting events.

Optionally, the selected location is selected based on more of the users providing the user indication of the preference for the upcoming meeting at the selected location than one or more other locations of the locations.

Optionally, the selected location is selected based on more of the users providing the user indication of the preference for the upcoming meeting at the selected location than all other locations of the locations.

Optionally, the method also includes automatically making a reservation for the upcoming meeting at the selected location.

In one embodiment, a system includes one or more processors configured to communicate several different locations for an upcoming meeting of a group of users to user devices of the users. The one or more processors are configured to, for each of the different locations, receive a user indication from each of the users of a preference for the upcoming meeting at the location or a disfavor for the upcoming meeting at the location. The one or more processors also are configured to select one of the locations as a selected location for the upcoming meeting based on the user indications and communicate the selected location that is selected to the user devices.

Optionally, the locations are associated with different businesses.

Optionally, the locations are associated with different restaurants.

Optionally, the locations are associated with different bars.

Optionally, the locations are associated with different sporting events.

Optionally, the one or more processors are configured to select the selected location based on more of the users providing the user indication of the preference for the upcoming meeting at the selected location than one or more other locations of the locations.

Optionally, the one or more processors are configured to select the selected location based on more of the users providing the user indication of the preference for the upcoming meeting at the selected location than all other locations of the locations.

Optionally, the one or more processors are configured to make a reservation for the upcoming meeting at the selected location.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
communicating several different locations for an upcoming meeting of a group of users to user devices of the users;
for each of the different locations, receiving a user indication from each of the users of a preference for the upcoming meeting at the location or a disfavor for the upcoming meeting at the location;
selecting one of the locations as a selected location for the upcoming meeting based on the user indications; and
communicating the selected location to the user devices.

2. The method of claim 1, wherein the locations are associated with different businesses.

3. The method of claim 1, wherein the locations are associated with different restaurants.

4. The method of claim 1, wherein the locations are associated with different bars.

5. The method of claim 1, wherein the locations are associated with different sporting events.

6. The method of claim 1, wherein the selected location is selected based on more of the users providing the user indication of the preference for the upcoming meeting at the selected location than one or more other locations of the locations.

7. The method of claim 1, wherein the selected location is selected based on more of the users providing the user indication of the preference for the upcoming meeting at the selected location than all other locations of the locations.

8. The method of claim 1, further comprising:
automatically making a reservation for the upcoming meeting at the selected location.

9. A system comprising:
one or more processors configured to communicate several different locations for an upcoming meeting of a group of users to user devices of the users, the one or more processors configured to, for each of the different locations, receive a user indication from each of the users of a preference for the upcoming meeting at the location or a disfavor for the upcoming meeting at the location, the one or more processors also configured to select one of the locations as a selected location for the upcoming meeting based on the user indications and communicate the selected location that is selected to the user devices.

10. The system of claim 9, wherein the locations are associated with different businesses.

11. The system of claim 9, wherein the locations are associated with different restaurants.

12. The system of claim 9, wherein the locations are associated with different bars.

13. The system of claim 9, wherein the locations are associated with different sporting events.

14. The system of claim 9, wherein the one or more processors are configured to select the selected location based on more of the users providing the user indication of the preference for the upcoming meeting at the selected location than one or more other locations of the locations.

15. The system of claim 9, wherein the one or more processors are configured to select the selected location based on more of the users providing the user indication of the preference for the upcoming meeting at the selected location than all other locations of the locations.

16. The system of claim 9, wherein the one or more processors are configured to make a reservation for the upcoming meeting at the selected location.
